(19) United States
(12) Patent Application Publication
(10) Pub. No.: US 2017/0046695 A1
(43) Pub. Date: Feb. 16, 2017

(54) METHODS AND APPARATUS FOR GIFTING GOODS OR SERVICES

(71) Applicant: MasterCard International Incorporated, Purchase, NY (US)

(72) Inventor: Martin James Collings, Cheltenham (AU)

(21) Appl. No.: 15/234,395

(22) Filed: Aug. 11, 2016

(30) Foreign Application Priority Data
Aug. 11, 2015 (SG) 10201506233Y

(51) Int. Cl. G06Q 20/40; G06K 19/06

(52) U.S. Cl. CPC G06Q 20/40; G06K 19/06037

(57) ABSTRACT

A computer-implemented gifting system is proposed in which a computer system generates a gift card associated with a payment account of a giver. The gift card is transmitted to a recipient, who may present the gift card to a merchant to redeem the gift card. The payment account is debited only if and when the gift card is redeemed. Thus, the giver can give the gift card secure in the knowledge that he will only have to make a payment if the recipient uses the gift card. Preferably, the giver has the option to associate the gift card with a particular product, or a particular class of product, so that the giver can ensure that the gift card can only be redeemed for that product or class of products. Alternatively or additionally, the gift card may be associated with a predefined limit value, such that it can be redeemed for products only up to the predefined limit.

### CROSS-REFERENCE TO RELATED APPLICATION

This application is a U.S. National Stage filing under 35 U.S.C. §119, based on and claiming benefit of and priority to SG 10201506233Y filed Aug. 11, 2015.

### TECHNICAL FIELD OF THE INVENTION

The present disclosure relates to methods and systems for generating and fulfilling an order for a gifted item.

### BACKGROUND OF THE INVENTION

It is common for merchants providing good and/or services (collectively referred to here as “products”) to issue vouchers which can be redeemed for products. Frequently, these gift cards are in the form of gift cards, which are sold to individuals (“givers”) who wish to give a gift to other individuals (“recipients”). Recently certain merchants which are e-commerce websites have also provided givers with the option to purchase electronic gift cards which can be emailed to recipients, so that the recipients can redeem them at the e-commerce websites. The merchants benefit from the gift card system in several ways. One is that by marketing the gift certificates to the givers, they are in effect able to lock in a second client base (the recipients) who might otherwise have obtained the products elsewhere.

A more subtle advantage of the gift card system is that frequently the recipients do not redeem the gift cards, so that the merchant makes an unearned profit equal to value of the gift card. For example, the recipient may lose the gift card, or may not want to purchase any product sold by the merchant, or may simply not take the required action to use the gift card within a period of validity of the card. Even if the recipient uses a portion of the gift card, they may not use all of it. For example, if a recipient receives a gift card worth 20 dollars, they may use it to buy a product costing 18 dollars and not make use of the rest of the value. In this case, the merchant makes a profit equal to the difference in value between the price the giver pays for the gift card and the retail price of the product which the recipient buys with the gift card.

Givers are often aware that there is a chance that at least part of the money they have paid for the gift card will be wasted in this way. However, they are prepared to run this risk due to advantages the gift card system provides. These include the fact that in many cultures it is more socially acceptable to give a gift card than to give cash. Furthermore, the giver may be pleased that the recipient is required to spend the gift card in a certain way. For example, by giving a student a gift card redeemable only for books, it can be ensured that the student purchases books, if the student redeems the gift card at all. Having said that, there is still a risk that the student will use the gift card to purchase a book which the giver would not wish to give the student, or to purchase a completely different product which a bookshop happens also to sell.

There are further limitations in how gift cards are presently used. For example, it is rare to give a gift card for a low face value (e.g. under 5 US dollars). Possibly this is because there is a perception that receivers may not consider such a gift card to be sufficiently valuable to make use of it, so the risk that they will not use it is off-putting.

### SUMMARY

In general terms, the present disclosure proposes that a giver can generate a gift card associated with a payment card of the giver. The payment card is associated with a payment account of the giver, and the payment account is debited only if and when the gift card is redeemed by the recipient of the gift card.

Thus, the giver can give the gift card secure in the knowledge that he will only have to make a payment if the recipient uses the gift card. This may be expected to make the giving of gift cards more widespread, and encourage the use of gift cards even in cases in which the giver is uncertain that they will be redeemed.

Preferably, the giver has the option to associate the gift card with a particular product, or a particular class of product, so that the giver can ensure that the gift card can only be redeemed for that product or a product in that class of products. This too will encourage givers to give the gift card.

Alternatively or additionally, the gift card may be associated with a predefined limit value (e.g. 10 US dollars), such that it can be redeemed for products only up to the predefined limit value.

The gift card may further be associated with a particular merchant, or set of merchants, such that it can only be redeemed at that merchant or set of merchants. This would encourage a merchant, or set of merchants, to permit the gift card to be available at a discount, so as to make it more likely that their products will be sold.

The term “gift card” in this document is used this document to mean a message transmitted to a recipient and indicating that the giver wishes to give the recipient a gift. The gift card typically contains a data file—optionally in the form of an image incorporating data, such as a QR (Quick Response) code or barcode. The gift card is typically a digital message transmitted electronically, such as by email. This makes the gift card more secure than gift card of the type which is transmitted by mail.

The term “redeeming the gift card” is used to mean that the recipient of the gift card attempts to obtain a product from a merchant with at least part of the payment being provided using the gift card, to that the payment for the product is made using the giver's payment card.

In one possibility, the giver may be provided with a software application running on a communication device, such as a mobile communication device of the giver, which allows him to generate a gift card in the form of a data file, and transmit the data file to the recipient. The term “communication device” refers a piece of equipment or hardware which is capable of transmitting and receiving data electronically. It may be a computer device such as a mobile phone (e.g. smartphones or conventional/feature phones), a tablet, a desktop computer, a laptop computer or a smart watch etc.

Conveniently, this may be integrated with any of several existing software applications which enable remote ordering (or any similar software application which may be proposed in the future), or any other method of purchase away from a traditional point of sales terminal (cash register). Such software applications are typically implemented using a using a mobile phone or tablet, but are not limited to these devices. One such system is the “Qkr!” software application (“app”). Qkr! (pronounced “quicker”) is a mobile payment application developed by MasterCard International Inc., for the purpose of ordering products and services through a smartphone with payments charged to an associated payment card which is pre-linked to the application. It is being deployed for use in large scale events, such as sport events. Users can open the application, scan a QR (quick response) code located for example on the back of the seat in front of them, and place orders for refreshments of their choice. The order is dispatched to a nearby concession stand, from where a runner delivers the items to the users' seats. It is already known to use Qkr! in other contexts, for example such that users are able to purchase school lunches or pay for school trips. Furthermore, it is known to use a Qkr! application running on a computing device to store discount vouchers for use by the owner of the computing device.

The software application may transmit the gift card to a communication device of the recipient. For example, a user might be able to scan a QR code at a first location (such as a retail outlet) and transmit the gift card to the recipient to use at any desired second location where merchants offer products compatible with the gift card. The software application may have access to payment card information, which may be incorporated (typically in encrypted form) into the data file.

If the communication device is a computing device (e.g. a mobile computing device) on which compatible software is installed, the gift card may be registered by the software, such that the recipient can redeem the gift card by presenting a computing device to a merchant (a POS (point-of-sale) terminal or a merchant server) to buy a product compatible with the gift card.

The data file included in the gift card may include payment data sufficient to initiate a payment authorization request sent to a payment network using the payment card. The payment data is sufficient to identify the payment card. In a first possibility, the payment data may be the payment card identity data itself (e.g. a 16-digit PAN (primary account number), and optionally other data stored such as an expiry date of the payment card, typically in an encrypted form. Alternatively or additionally, the software application may access the payment network at the time that the gift card is generated, and obtain a token linked to the payment account, and in this case the payment data is the token (possibly in an encrypted form).

The computing device of the merchant may be able to extract the payment data from the gift card, and transmit it to a payment network as part of a payment authorization request. Thus, if the payment data is a token, when the recipient uses the gift card the token is transmitted back to the payment network which may then authorize a transaction.

Optionally when the software application asks the payment network for a token it may specify the limit value. The payment network may either store this limit value in association with a record of the token, or incorporate the limit value into the token. In this case, when the payment network receives the token as part of the authorization request, the payment network may only authorize a transaction up to the predetermined limit value.

The gift card may be stored by the software of the recipient's computing device, so that, unlike a conventional paper gift card, there is little risk of it being lost or forgotten. The recipient may receive a notification that the gift card has arrived, and optionally reminders of the existence of the gift card, for example shortly before the gift card is due to expire.

If the recipient does not have a computing device on which compatible software is installed, the recipient may be able to receive the gift card by email or on paper, and present the gift card to a compatible merchant to redeem a compatible product.

In another possibility, the present gift card could be generated by an e-commerce website to which the giver connects using a communication device. Certain websites store a database of payment card identity data for users who have previously registered there, so such a website would be able to permit a giver who is a registered user to send a gift card to a recipient and only charge the giver's payment card if the gift card is redeemed. In another possibility, the giver might leave the merchant with information sufficient for the merchant to access a mobile wallet where the giver has previously recorded payment card identity data (such as the MasterPass mobile wallet system operated by MasterCard International Inc.), so that the merchant is able to charge the giver's payment card only if the gift card is redeemed. Note that in both these cases, the gift card would not have to include the payment data, since the e-commerce website would be able to initiate a payment transaction using the stored payment card identity data, or the stored information sufficient to access the mobile wallet.

Since the giver's payment account is charged only when the gift card is redeemed, a recipient may be concerned that at that time the payment may be refused, e.g. if the payment account contains insufficient funds at the time the gift card is redeemed. One way to overcome this problem would be for the issuer bank to reserve a certain sum of money sufficient to redeem the gift card at the time the gift card is issued, with the reservation of only being cancelled upon the expiry of the gift card. However, this means that sums in the giver's payment account may have to be reserved for an unacceptably long time (most card issuing banks are only prepared to reserve money for periods up to a duration in the range 24 hours to 3 days). Even if this problem could be overcome, the reserved sums would limit the number of gift cards which the giver could give, even if in practice few of them were used. Therefore, a more preferable solution is for the gift card recipient to be able to verify just before redeeming the gift card that the gift card will be honored, e.g. by querying the merchant where the recipient intends to use the gift card. Optionally, when this is done, the value of the gift card may be pre-authorized, i.e. reserved by the issuer bank for a predefined time (e.g. a window of 24 hours starting at the time that the verification step is carried out) such that the gift car will certainly be honored provided it is redeemed within the predefined time. For example, a gift card recipient may be able to verify at a merchant which is a restaurant that the gift card will be honored before consuming food and/or drink at the restaurant.

As used in this document, the term “payment card” refers to any cashless payment device associated with a payment account, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers.

### BRIEF DESCRIPTION OF THE DRAWINGS

Embodiments of the invention will now be described as of non-limiting examples only, with reference to the following drawings in which:

FIG. 1 is a schematic diagram of a first embodiment of the invention in which a giver employs a mobile communication device to transmit a gift card to a recipient;

FIG. 2 shows the steps of a method performed by the embodiment of FIG. 1;

FIG. 3 shows a screen displayed by the communication device of the embodiment of FIG. 1;

FIG. 4 is a schematic diagram of a second embodiment of the invention in which a gift giver employs an e-commerce website to transmit a gift to a recipient;

FIG. 5 shows the steps of a method performed by the embodiment of FIG. 4;

FIG. 6 is a block diagram illustrating a technical architecture of server system which can be used in the embodiments of FIGS. 1 and 4; and

FIG. 7 is a block diagram illustrating a technical architecture of a communication device of the embodiments of FIG. 1 and FIG. 4.

### DETAILED DESCRIPTION

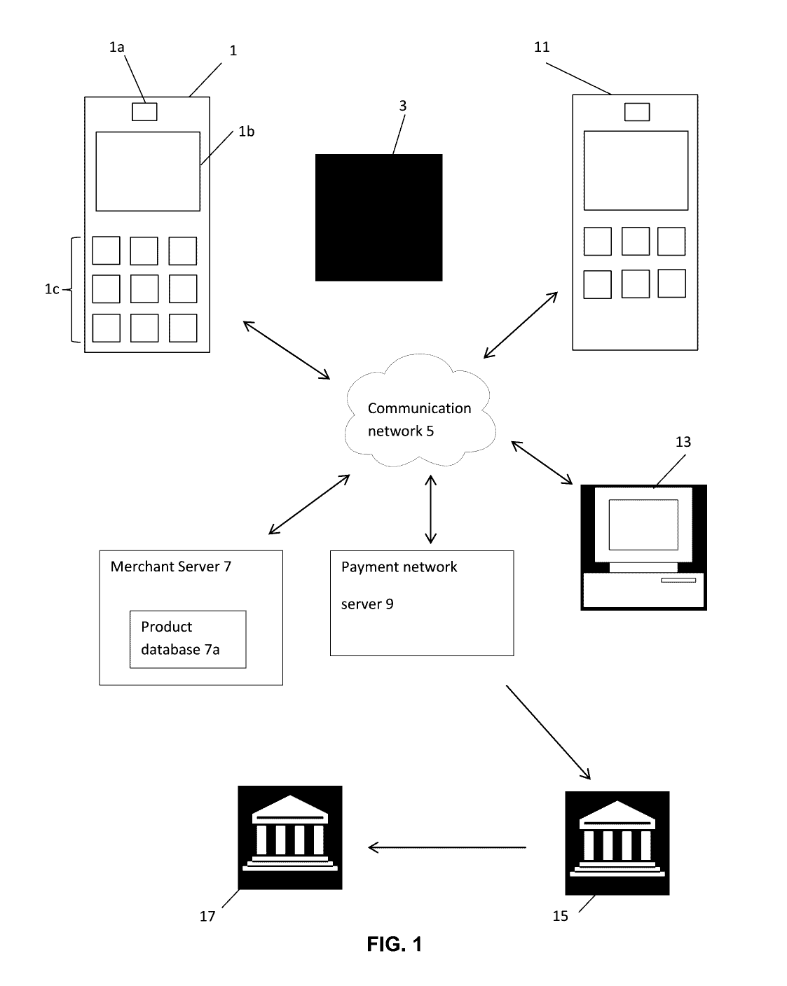

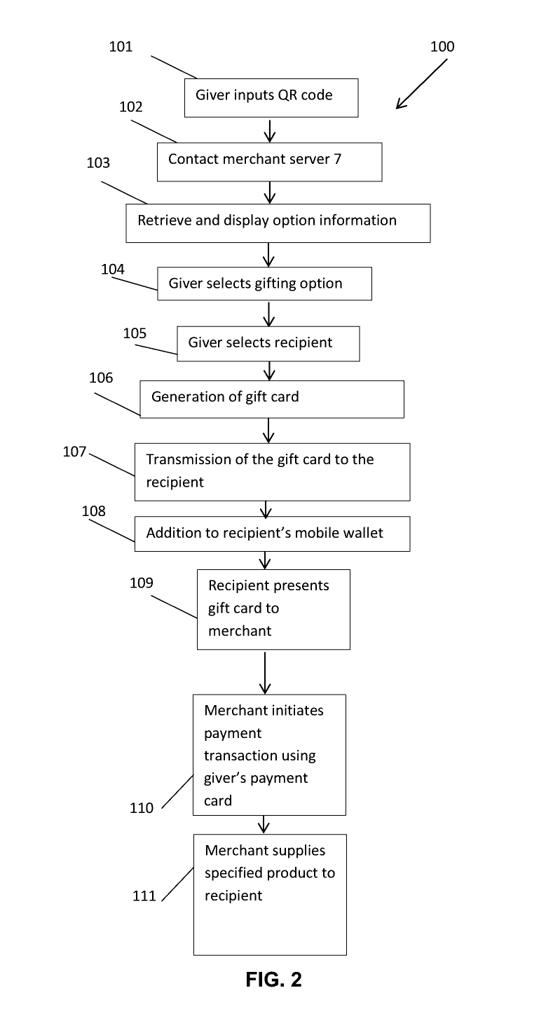

Referring firstly to FIG. 1, an embodiment of the invention is shown. Steps of a method 100 performed by the embodiment are shown in FIG. 2, and explained as follows.

The embodiment includes a mobile communication device 1 having a camera 1a, a screen 1b and a data input device such as a keyboard 1c. The user of the mobile communication device 1 is an individual here referred to as a “giver”. The giver is assumed to be in a retail location operated by a merchant, and the embodiment allows the giver to generate a gift card to be sent to a second individual (a “recipient”).

In one form the gift card may be associated with a specific product (below we discuss a variation of the method in which this is not the case). The giver may find this product (a good, or possibly a service) in the retail location, and consider that the recipient would like to receive it. The item is typically displayed together with a QR code 3.

In step 101 the giver uses the camera 1a to capture an image of the QR code, and a first software application running on the mobile communication device 1 extracts information from the QR code identifying the product, and in step 102 the communication device 1 uses a communication network 5 (such as the internet, which the communication device 1 may be able to access using a Wi-Fi network provided at the retail location, or using another wireless telecommunication network) contact a server 7 operated by the merchant who operates the retail location, and transmits to the merchant server 7 the data identifying the product. Typically the QR code contains the data identifying the product, and also a communication address of the merchant server 7 (e.g. an internet address). Alternatively, the communication address of the merchant server 7 may have been communicated to the mobile device 1 earlier, such as when the giver entered the retail location.

In a variation of the system above, the product is not displayed with a QR code, but it is displayed with a label containing other data (such as a barcode, or with an alphanumeric name or codename which the user may read). The user is able to enter the other data into the communication device 1, such as by scanning the barcode or by typing the alphanumeric name or codename into the communication device, such as using a keyboard 1c. The other data includes the data identifying the product, and optionally also includes the communication address of the server 7.

In step 103, the merchant server 7 uses the QR code (or other data) to extract information about the product from a product database 7a. The merchant server 7 uses the communication network 5 to transmit to the communication device 1 the information about the product, which is displayed using the screen 1b.

Typically, there are several options associated with the product (e.g. if the product is an item of clothing the options may be respective sizes and/or colour options) and these are displayed to the giver using the screen 1b. In this case, the user optionally selects one of the options (e.g. by touching the screen lb if it is touch sensitive, or by using the keys 1c). If the user does not select one of these options, then the gift card produced by the process (see below) will be applicable to products according to any of the options (i.e. a class of products).

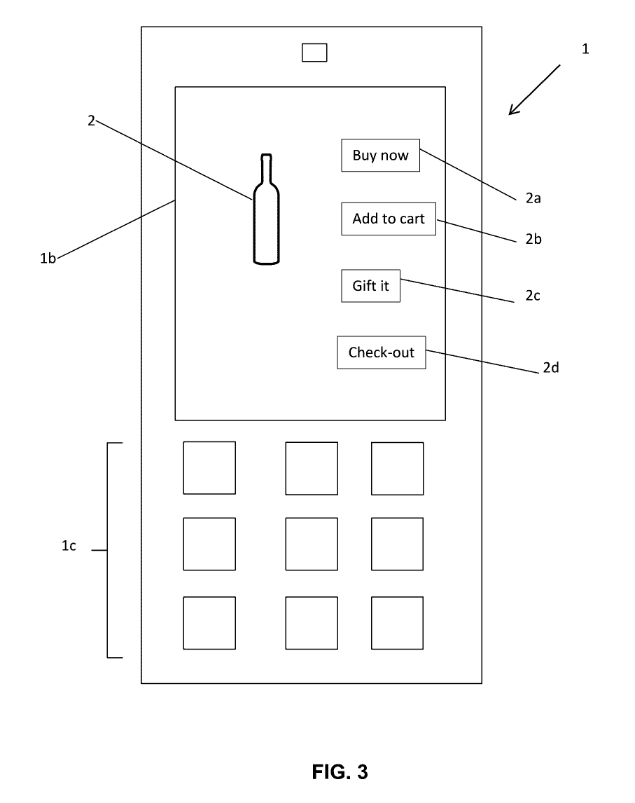

At this stage the screen lb of the communications device is as shown in FIG. 3. The screen lb is assumed in the following discussion to be touch-sensitive so that options can be selected by touching corresponding areas of the screen; alternatively, the data input keys 1c may be used to select this options.

The screen lb displays information 2 about the product, such as a picture of it, and a number of options displayed in corresponding areas on the right of the screen. One of the options may be for the giver to buy the product at once (“buy now”). If the user selects this option by touching the corresponding area 2a of the screen, the giver may be able to collect the item at the retail location, or it may be delivered to the giver, in a manner similar to that of a known commerce system. Another of the options may be for the giver to place the product into a virtual shopping cart (“Add to cart”, as displayed in corresponding area 2b), i.e. a data record is created and stored (typically on the communication device 1) indicating that the giver has selected the product. Again, this is an option which exists in known commerce systems.

A third option would be for the giver to select a “gift it” option, displayed in the corresponding area 2c. Selecting this option is step 104 of the method. In this case, the communication device moves to steps 105 and 106 described below, in which a gift cart is generated and supplied to a recipient, to allow the recipient to buy the product.

Alternatively, once the giver has used the “Add to cart” option displayed in corresponding area 2b, to add one or more products to the shopping cart, the giver can select a “Go to check out” option displayed in corresponding area 2d. In this case, the communication device displays an interface which allows the giver to purchase of the one of more products previously added to the virtual shopping cart. At this stage the giver may either buy the one or more items in the virtual shopping cart in a conventional manner, or he or she may select a “Gift it” option (to facilitate this option, the screen 1b may display a “gift it” button at this time). This is another example of how step 104 of the flow diagram can be performed. Once this is done steps 105 and 106 (below) are initiated in respect of the products in the virtual shopping card, in order to generate a gift certificate covering all the items in the shopping cart.

In step 105, the giver specifies a recipient of the gift card. The giver may be able to do this by specifying a communication address of the recipient, for example an email address or a telephone number. Optionally, the software application may store a list of recipients which the giver has previously specified and for whom a communication address has already been provided and stored in a database (e.g. in the communication device 1). This list may comprise or consist of one or more recipients to whom the giver has previously sent a gift card. If such a list exists, step 105 may consist of the user choosing one of these pre-specified recipients and extracting the corresponding communication address from the database. Conveniently, the communication device 1 may generate a drop down list of the recipients on the list, so that the giver can choose one, for example by touching the touch-sensitive screen.

In step 106, a gift card is generated. The gift card is a digital message containing a data file. The data file contains data specifying the product which the giver selected in steps 101 (together with any further options the giver chose in step 103). It further contains payment data indicative of the payment card associated with the giver. Typically, it also contains data specifying the merchant which operates the server 7. In this case, the recipient may be limited to redeeming the gift card from the specified merchant (although not necessarily the same retail outlet of the merchant as the one where the giver was when the gift card was generated). The gift card may further include data specifying an expiry date of the gift card. This expiry date may be specified by the giver, or may be a default value, such as one which is a predetermined time after the time at which the gift card is generated. For example, by default the gift card may be valid for 30 days, or the gift card may be redeemed only on weekdays (but not on weekends).

The payment data may, in a first form, be an encrypted form of payment card identity data issued with the payment card, i.e. if the payment card is a physical card, the payment card identity data printed on the payment card. The payment card identity data may comprise a 16-digit PAN (primary account number), and optionally other data such as an expiry date of the payment card, and any or all of this data may be incorporated into the payment data. Some or all of the payment card identity data may be stored (e.g. in encrypted form) within the communication device 1, so that the giver does not have to enter it into the communication device 1 to generate the gift card.

Alternatively, the software application may be operative to contact a server 9 of a payment network (such as the one operated by MasterCard International Inc.) for processing payment transactions using the payment card of the giver. The software application may transmit some or all of the payment card identity data to the payment network server 9, and in return the payment network server 9 generates and transmits to the software application a token which can be used as the payment data included in the data file of the gift card. Techniques are known for generating a token, such as using the PAN number of the payment card.

As explained below, the payment network may store a record of the token, so that it can recognise it in the future. Optionally, the software application may notify the payment network server 9 of the value of the product, and the payment network may store this value together with the record of the token. When the gift card is presented to a merchant (as described below), the payment network will not authorize a transaction for more than this specified value.

Alternatively, rather than the payment network storing a record of the token, it may be operative to perform a secret algorithm to convert the token to regenerate the PAN data from the token.

In step 107, the communication device 1 transmits the gift card to a communication device 11 of the specified recipient using the associated communication address. The communication device 11 may be a mobile communication device. As described below, the recipient can redeem the gift card and initiate a payment transaction using the payment card associated with the giver. When the gift card is sent, a message to this effect may be displayed on the screen lb of the communication device 1 to specify that this has been done. The message may include text of the form “Your payment card will only be charged if and when the recipient redeems your gift”.

The gift card may be transmitted as an email message. Optionally, the recipient may print it out. When the gift card has been transmitted, a record of that fact is stored in the giver's communication device 1. For example, the software application on the communication device may be operative to display an image including a list of gift cards transmitted by the communication device 1. If any of the gift card(s) have not yet been redeemed, the list of gift cards may indicate this, e.g. by showing the portions of the image relating to such gift card(s) in a different color.

Optionally, the communication device 11 may contain a second software application operative to recognize the gift card. If so, the gift card is recognized in optional step 108. To cause the second software application to recognize the gift card, the recipient may optionally forward the email message containing the gift card from an email program running on the communication device 11 to the second software application. Or the recipient may scan a print out of the gift card into the second software application. For example, the gift card may comprise the data file in the form of a QR code (or other image) which the second software application can decode. If the second software application recognizes the gift card, in step 108 the second software application may store data obtained from the gift card in a wallet (e.g. stored on the communication device 11), as a record of the gift card.

In one example, the first software application and the second software application may be compatible, such as applications issued by the same commercial organization (such as the payment network), and the recipient may be registered with the commercial organisation. In this case, in step 107 the communication device 1 and/or the payment network may be operative to recognise that the recipient is registered with the commercial organisation. For example, the first software application running on the communication device 1 may be operative to interrogate a database maintained by that commercial organisation, e.g. using an email address of the recipient. If the communication device 1 recognises that the recipient is associated with the commercial organisation, the gift card may be transmitted directly from the first software application to the second software application (i.e. without the recipient having to take any action).

The communication device 11 may be operative to display to the recipient a list of the gift card(s) the recipient has received, and registered with the second software application. The second software application may further be operative to display any respective expiry date associated with the gift card(s) (i.e. determined by the expiry data contained in the gift card), and to cause the communication device 11 to generate reminders to the recipient before the gift card(s) expire.

In step 109, the recipient the recipient presents the gift card to the merchant, within any expiry period specified by the expiry data, and asks to buy the product specified by the gift card. If the gift card specifies only a class of products, the recipient may select a product offered by the merchant within that class.

One way in which this may be done is for the recipient to take the communication device 11, or the print-out of the gift card, to an outlet of the merchant (typically the merchant which operates the server 7) where there is a point-of-sale (POS) device 13 (i.e. a computer apparatus of the merchant). The point of sale device 13 is operative access the data file in the gift card. For example, the POS may include a scanner, and if, as described above, the data file is stored in the gift card as a QR code or other image, the POS may use the scanner to read the gift card data file from the screen of the communication device 11 or from a print-out of the gift card. Alternatively, if the gift card has been registered with a second software application running on the communication device, the second application software may be operative to send data from the data file of the gift card from the second application (e.g. wirelessly) to the POS device 13.

Another way in which the recipient may be able to present the gift card to the merchant may be for the recipient to contact another computer apparatus of the merchant, namely the merchant server 7. The recipient supplies the data file from the gift certificate to the merchant server 7 (e.g. using the second software application). In this case, the user may be able to order the product to be delivered to the recipient.

The POS terminal 13 or merchant terminal 7 typically checks that the expiry date of the gift card has not expired. If it has, the method terminates, and the gift card is rejected. Otherwise, the following steps are performed.

The POS terminal 13 or the merchant terminal 7 is operative in step 110 to transmit an authorization request message to the payment network server 9, to intiate a payment transaction in which the product specified by the gift card, optionally with further options specified by the recipient (e.g. if the recipient selects a product within a class specified by the gift card), is purchased by the recipient using the payment card of the giver. In this process, the POS terminal 13 or the merchant terminal 7 sends the authorization request message including the payment data from the gift card to the payment network server 9. As noted before, the payment data may be encrypted, and may be in the form of a token which the payment network server 9 may recognise as associated with the payment card.

The payment network server 9 may make a determination of whether to authorize the payment transaction (e.g. by communicating with an issuer bank 15 of the payment card to determine whether they value of the payment transaction is within a credit limit associated with the payment card). If so, the payment network server 9 sends a corresponding authorization message to the POS terminal 13 or the merchant terminal 7. Upon the POS terminal 13 or merchant 7 receiving the authorization message, the recipient is supplied with the specified products (step 111). Further, the payment network sends a payment message to the issuer bank 15, to instruct it (e.g. at some later time) to make a payment to a receiving bank 17 (also called acquiring bank) where the merchant maintains an account. This process may be according to existing payment protocols.

In the explanation above, the gift card is associated with a product. However, this is not the only way in which the embodiment may be used. Rather, the QR code 3 (or other data) which the giver enters into the communication device in step 101 may simply specify a merchant (or a group of two or more merchants) rather than a specific product. In other words, step 101 would just amount to selecting this merchant (or group of merchants). In this case, step 102 of contacting the merchant server 7 may be unnecessary, or may just relate to selecting options relating to the gift card, rather than the product the gift card can be used to purchase. The options which are displayed to the giver in step 103 may, for example, include an option for a limit value of a gift card, and the giver would select the limit value. The amount of this limit value would be incorporated into the gift card generated in step 106. Steps 105, 107 and 108 are the same in this variant as explained above. Step 109 would the same also, except that the recipient would be able to specify any one of more products offered by the merchant. If the specified product(s) have a cost below the selected limit value, then the POS terminal 13 or merchant server 7 may would in step 110 send a payment authorization request for a payment transaction for the value of the specified product(s). Conversely, if the specified products have a cost above the selected limit value, then the POS terminal 13 or merchant server 7 would send a payment authorization request for a payment transaction for the selected limit value, and require the recipient to pay the difference between the selected limit value and the value of the specified product(s).

If the specified product(s) have a cost below the selected limit value, then the POS terminal 13 or merchant server 7 would provide the products to the recipient upon receiving an authorization message from the network server 9 (step 111). Conversely, if the specified products have a cost above the selected limit value, in step 111, the specified products would be supplied to the recipient only upon the POS terminal 13 or merchant server 7 receiving both the authorization message relating to the payment transaction from the payment network, and payment from the recipient of the difference between the selected limit value and the value of the specified products.

In certain situations, the recipient may be concerned that the payment may be refused, e.g. if the payment account contains insufficient funds at the time the gift card is redeemed. For that reason, the recipient may be able to interrogate the POS terminal 14 or merchant server 7 without initiating the payment, to verify that the gift card will be honoured if it is used within a predetermined time. For example, a gift card recipient may be able to verify at a merchant which is a restaurant that the gift card will be honoured before consuming food and/or drink at the restaurant. Optionally, when the recipient verifies that the gift card will be honoured, the value of the gift card is pre-authorized, i.e. reserved by the issuer bank, so that the gift card is guaranteed to be honours providing it is used within a predetermined time.

Many variations of the embodiment above are possible within the scope of the invention. For example, although as described above, the gift card is generated by the software application on the communication device 1, an alternative is for software application on the communication device 1 to control the payment network server 9 (or indeed another server not shown in FIG. 1) to generate the gift card, and transmit the gift card to the communication device 11. This would allow the software application on the communication device 1 to be simpler. For example, it might just take the form of browser data displaying a graphical user interface generated by the payment network server 9 (or other server).

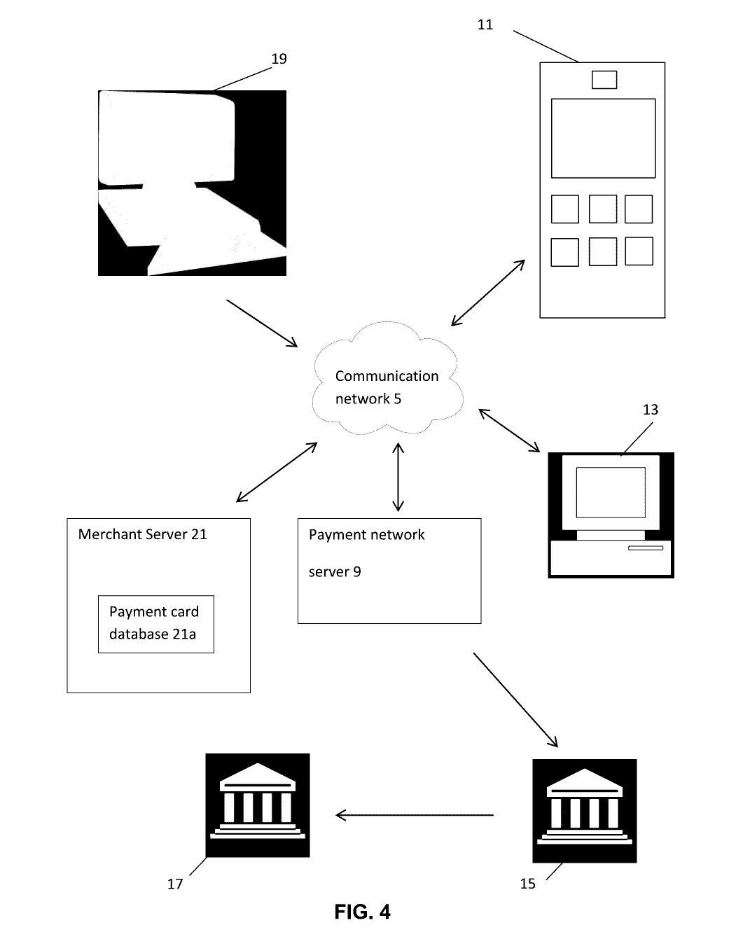

Yet a further variation of the embodiment of FIG. 1 is shown in FIG. 4. Elements of FIG. 4 which are identical to those of FIG. 1 are given the same reference numerals. In the embodiment of FIG. 4, the merchant server 7 of the first embodiment is replaced by a merchant server 21 which operates an e-commerce website. The communication device of the giver may be any communication device 19 which is capable of communicating with the merchant server 21 using the communication network 5. It is not limited to devices having a camera.

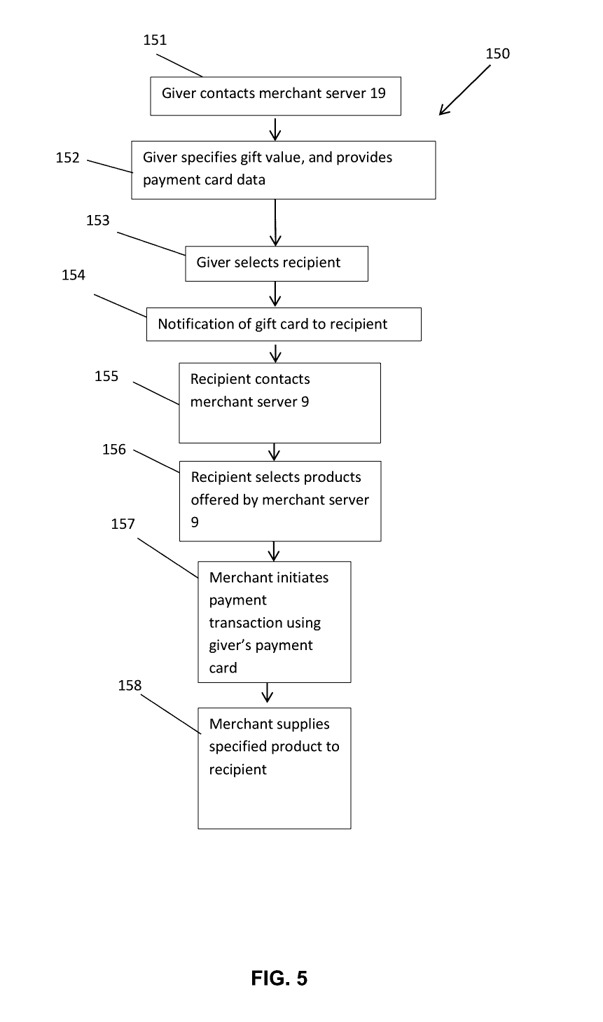

The embodiment of FIG. 4 performs the method of FIG. 5. In a first step 151 the giver uses the communication device 19 to contact the merchant server 21 over the communication network 5, for example using a browser running on the communication device 19.

In step 152, the giver specifies to the merchant server 21 the limit value of a gift card (and optionally goods which may be purchased using the gift card) and provides payment card identity data (e.g. PAN number, expiry data and/or CVC code) describing the giver's payment card. The merchant server 21 stores the payment card identity data in a database portion 21a (e.g. in encrypted form).

In step 153, the giver provides a communication address for a communication device 11 of a recipient of the gift card. As in the method of FIG. 2, this may be done by selecting a predefined recipient for whom the communication address has already been provided.

In step 154, the merchant server 21 sends a gift card to the recipient using the communication address. The gift card contains a data file containing at least data specifying the identity of the merchant server. It typically includes the limit value and the identity of the recipient. The gift card is associated with the payment card of the giver (e.g. it may include a code number which is associated with the payment card by a data record maintained in the database portion 21a of the merchant server 21), but it does not have to include the payment card identity data.

In step 155, the recipient logs onto the merchant server 21 and verifies her/her identity, for example by returning to the merchant server 21 a code contained in the notification. In step 156, the recipient specifies one or more product(s) offered by the merchant, using the e-commerce website provided by the merchant server. The recipient provides any data required for the product(s) to be delivered to the recipient (e.g. supplying delivery address data in the case of that a specified product is a good).

In step 157, the merchant server 21 transmits an authorization request message to the payment network 9, to initiate a payment transaction. The authorization request includes the payment card identity data of the giver stored in the database 21a. If the specified product(s) have a cost below the selected limit value, then the merchant server 21 would in step 157 initiate a payment transaction for the value of the specified product(s). Conversely, if the specified products have a cost above the selected limit value, then merchant server 21 would initiate a payment transaction for the selected limit value, and require the recipient to pay the difference between the selected limit value and the value of the specified product(s).

The payment network 9 determines whether to authorize the transaction, and if this determination is positive, the payment network 9 sends the merchant 21 an authorization message confirming that they payment transaction will be successful. The payment network 9 then initiates the payment by sending an instruction to the issuing bank 15 to make a payment to a receiving bank 17 where the merchant which operates the merchant server 21 maintains an account.

If the specified product(s) have cost below the selected limit value, then the merchant 21 would, upon receiving an authorization message from the payment network 9, supply the specified product(s) to the recipient (step 158). Conversely, if the specified products have a cost above the selected limit value, then the specified products would be supplied to the recipient only upon merchant server 21 receiving both the authorization message relating to the payment transaction from the payment network, and payment from the recipient of the difference between the selected limit value and the value of the specified products.

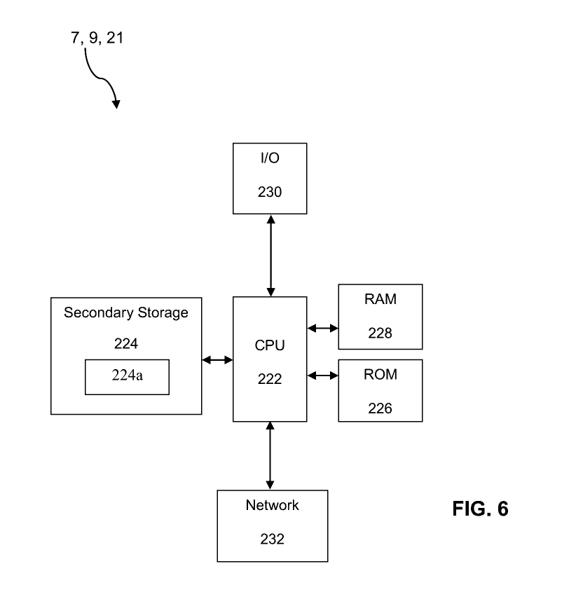

FIG. 6 is a block diagram showing a technical architecture of the payment network server 9. The merchant servers 7 or 21 may also have this technical architecture.

The technical architecture includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has an order processing component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

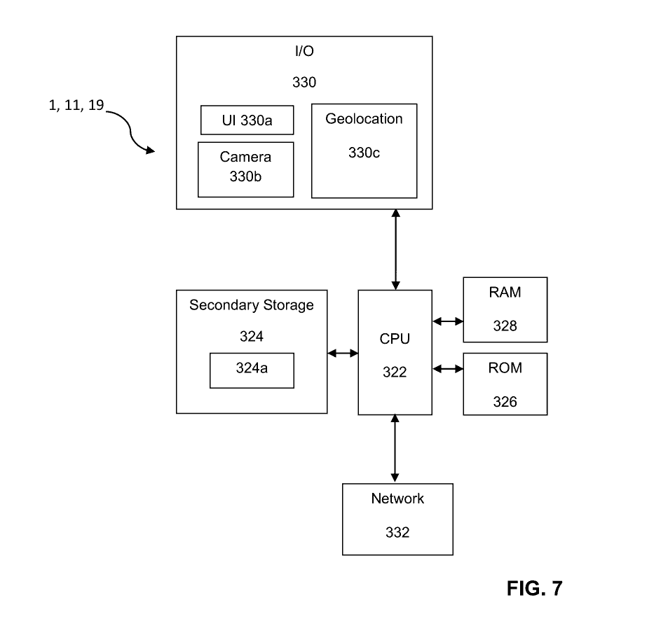

FIG. 7 is a block diagram showing a technical architecture of any one the communication devices 1, 11, 19. It is envisaged that in embodiments, the communication devices 1 and 11 will be a smartphone or tablet device, and the communication device 19 may take any form.

The technical architecture includes a processor 322 (which may be referred to as a central processor unit or CPU) that is in communication with memory devices including secondary storage 324 (such as disk drives or memory cards), read only memory (ROM) 326, random access memory (RAM) 328. The processor 322 may be implemented as one or more CPU chips. The technical architecture further comprises input/output (I/O) devices 330, and network connectivity devices 332.

The I/O devices comprise a user interface (UI) 330a, a camera 330b and a geolocation module 330c. The UI 330a may comprise a touch screen, keyboard, keypad or other known input device. The camera 330b allows a user to capture images and save the captured images in electronic form. The geolocation module 330c is operable to determine the geolocation of the communication device using signals from, for example global positioning system (GPS) satellites.

The secondary storage 324 is typically comprised of a memory card or other storage device and is used for non-volatile storage of data and as an over-flow data storage device if RAM 328 is not large enough to hold all working data. Secondary storage 324 may be used to store programs which are loaded into RAM 328 when such programs are selected for execution.

In this embodiment, the secondary storage 324 has an order generation component 324a, comprising non-transitory instructions operative by the processor 322 to perform various operations of the method of the present disclosure. The ROM 326 is used to store instructions and perhaps data which are read during program execution. The secondary storage 324, the RAM 328, and/or the ROM 326 may be referred to in some contexts as computer readable storage media and/or non-transitory computer readable media.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 332 may enable the processor 322 to communicate with the Internet or one or more intranets. With such a network connection, it is contemplated that the processor 322 might receive information from the network, or might output information to the network in the course of performing the above-described method operations. Such information, which is often represented as a sequence of instructions to be executed using processor 322, may be received from and outputted to the network, for example, in the form of a computer data signal embodied in a carrier wave.

The processor 322 executes instructions, codes, computer programs, scripts which it accesses from hard disk, floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiment can be made within the scope and spirit of the present invention.

1. A computer-implemented method of providing to a recipient a product offered by a merchant, the method comprising:
(i) a first individual entering data into a computer device specifying a communication address associated with a second individual;
(ii) the computer device transmitting a gift card message to the second individual, the gift card message being associated with a payment card associated with the first individual;
(iii) the second individual requesting the product at a computer apparatus of the merchant;
(iv) the computer apparatus of the merchant, upon receiving the request for the product from the second individual, transmitting to a payment network an authorization request message requesting authorization of a payment transaction using the payment card, and
(v) upon the computer apparatus of the merchant receiving a message from the payment network that the payment transaction is authorized, supplying the product to the second individual.

2. A computer-implemented method according to claim 1, in which the gift card message comprises a data file comprising payment data specifying the identity of the payment card,
the second individual presenting the gift card message to the merchant, whereby the merchant can extract the payment data,
the merchant performing said step of transmitting the payment authorization request using the payment data as part of the payment authorization request.

3. A computer-implemented method according to claim 1 in which the computer device is the computer apparatus of the merchant, the computer apparatus of the merchant storing payment card identity data received from a communication device of the first individual, and including the payment card identity data in the payment authorization request.

4. A computer-implemented message according to claim 1 in which the gift card message is associated with a value limit, the payment transaction being for a value which is no higher than the value limit.

5. A computer-implemented method according to claim 1 in which the gift card message is associated with a specified product or a class of products, the product being the specified product or in the specified class of products.

6. A computer-implemented method according to claim 1, which the gift card is associated with an expiry time, the method comprising the computer apparatus of the merchant checking that the expiry time has not passed.

7. A computer-implemented method according to claim 1 further including the user using a camera to capture an image, the image encoding predefined data which is used in the generation of the gift card message.

8. A computer-implemented method according to claim 1 further including, prior to step (iii), the computer apparatus of the merchant contacting the payment network to pre-authorize the payment transaction.

9. A computer-implemented method according to claim 1 further including, prior to step (ii), recognizing that data associated with the second individual is present in a database, and upon this recognition in step (ii) the gift card message being transmitted in a predefined format for recognition by a software application installed on a communication device operated by the second individual.

10. A computer system, the computer system being operative to receive from a first individual:
payment card identity data specifying a payment card associated with the first individual;
a communication address associated with a second individual;
the computer system being operative to generate a gift card message and transmit the gift card message to the second individual using the communication device, the gift card message being associated with the payment card,
whereby the second individual upon receiving the gift card message can make a payment to a merchant using the payment card using data contained in the gift message.

11. A computer system according to claim 10 the computer system being operative to generate the gift card message comprising payment data generated using the payment card identity data, and specifying the payment card associated with the first individual.

12. A computer system according to claim 11 for operation by the first individual, the computer system having a screen, and being operative to display on the screen a list of one of more gift card messages transmitted by the computer system, with, for each gift card message, an indication of whether the corresponding gift card has been used to make a payment to a merchant.

13. A computer system according to claim 10, which is arranged to provide an e-commerce web site,
the computer system:
comprising a database to store the payment card identity data, and
being operative, upon being requested to provide a product to the second individual, to initiate a payment transaction using the payment card identity data, and to supply the product to the second individual upon receiving an authorization message in respect of the payment transaction.

14. A computer system according to any of claims 10, the computer system being operative to recognize the communication address associated with the second individual, and upon such recognition, to transmit the gift card message in a predefined format for recognition by a software application installed on the communication device.

15. A computer system for providing a product, the computer system comprising a processor and a data storage device storing program instructions,
the program instructions being operative, when implemented by the processor, to cause the computer system, upon receiving (a) gift card message including a data file incorporating payment data specifying a payment card associated with a first individual, and (b) a request for a product from a second individual;
to extract the payment data from the data file;
to initiate a payment transaction using the payment data by transmitting an authorization request to a payment network, and
upon receiving a message from a payment network that the payment transaction is authorized, to supply the product to the second individual.
